(19) United States
(12) Patent Application Publication
(10) Pub. No.: US 2005/0194077 A1
(43) Pub. Date: Sep. 8, 2005

(54) Process for retreading worn tires and the tires obtained therefrom

(76) Inventor: Choo Kiat Yap, Kota Kinabalu Sabah (MY)

Correspondence Address: KNOBBE MARTENS OLSON & BEAR LLP, 2040 MAIN STREET, FOURTEENTH FLOOR, IRVINE, CA, 92614, US

(21) Appl. No.: 10/896,634

(22) Filed: Jul. 21, 2004

(30) Foreign Application Priority Data
Mar. 2, 2004 (MY) PI 20040722

(51) Int. Cl. B29D 30/56

(52) U.S. Cl. 152/209.6; 156/96

(57) ABSTRACT

The present invention relates to a process for retreading worn tires and the tires obtained therefrom. The said process comprises the steps of selecting the worn tires which are fit to be retreaded, removing the treads of the worn tires, buffing the surface of the tires to the correct size, shape and texture, cementing the casing using a rubber compound, preparing new treads which suit the dimension of each casing, buffing the new treads using a buffing means, attaching the buffed treads onto the casing using a tire builder means and placing the retread tires in a curing chamber.

### BACKGROUND OF THE INVENTION

1. Field of Invention

The present invention relates to a process for retreading worn tires and the tires obtained therefrom.

2. Description of the Related Art

The retreading of tires is a process whereby worn tires or casings (when the worn treads are removed) receive new treads for use thereafter. There are several techniques for the production of retread tires and one of the techniques is known as the pre-cured method, which is well known to skilled artisans. Conventional retread tires by way of the pre-cured method are made through complex methodological processes. It can be costly in terms of the production (which includes machineries, electricity, waste and time), manpower, maintenance and performance. In the retreading industry, there is no method except for the conventional ones in which to produce retread tires. Immediately after the conventional method of tire building, the use of envelope, innerlope and curing rim are needed to ensure and protect the sealing of the new treads onto the worn tires/casings prior to curing. Furthermore and in addition, the newly built retread tires will also require the use of pressure hose, vacuum hose and coupling prior to curing. This will require time, manpower and other mechanisms.

### SUMMARY OF INVENTION

Accordingly, the present invention provides a process for producing retread tires, the said process comprises the steps of (a) selecting the worn tires which are fit to be retreaded, (b) removing the treads of the worn tires, (c) buffing the surface of the casings obtained from step (b) to the correct size, shape and texture, (d) cementing the casings using a rubber compound, (e) preparing new treads which suit the dimension of each casing, (f) buffing the new treads using a buffing means which is controlled by means of mechanical or pneumatic action, wherein the buffing means is provided with motor-driven steel rollers, side rails of permanent materials acting as a guide at each side of the said rollers and a platform made of a hardened material placed in a fixed position at each side just below the rotating steel brush in the buffing chamber and characterized in that speed in which the treads being transported into and out of the buffing means will be between 1 to 5 cm per second, the force of the buffing on the treads is between 1 to 7 kg and the speed of the buffing is between 1000 to 1800 rpm, (g) applying an industrial gum on the underside of the buffed treads, (h) attaching the buffed treads onto the casings using a tire builder means, wherein the tire builder means is provided with a controlled builder means for applying the treads onto the casings, side rollers, means of leveraging said rollers against the wing onto the shoulder of casings characterized in that pressure of the retread tires by inflating compressed air is between 100 to 400 kPa (1 to 4 bars) and pressure of the side rollers on the retread tires is between 200 to 600 kPa (2 to 6 bars) and (i) placing the retread tires in a curing chamber, characterized in that the chamber pressure is between 500 to 900 kPa (5 to 9 bars), the chamber temperature is between 70 to 100° C. and the time provided is between 3 to 4 hours.

Also provided retread tires obtained from a process for producing retread tires, the said process comprises the steps of (a) selecting the worn tires which are fit to be retreaded, (b) removing treads of the worn tires, (c) buffing the surface of the casings obtained from step (b) to the correct size, shape and texture, (d) cementing the casings using a rubber compound, (e) preparing new treads which suit the dimension of each casing, (f) buffing the new treads using a buffing means which is controlled by means of mechanical or pneumatic action, wherein the buffing means is provided with motor-driven steel rollers, side rails of permanent materials acting as a guide at each side of the said rollers and a platform made of a hardened material placed in a fixed position at each side just below the rotating steel brush in the buffing chamber and characterized in that speed in which the treads being transported into and out of the buffing means will be between 1 to 5 cm per second, the force of the buffing on the treads is between 1 to 7 kg and the speed of the buffing is between 1000 to 1800 rpm, (g) applying an industrial gum on the underside of the buffed treads, (h) attaching the buffed treads onto the casings using a tire builder means, wherein the tire builder means is provided with a controlled builder means for applying the treads onto the casings, side rollers, means of leveraging said rollers against the wing onto the shoulder of casings characterized in that pressure of the retread tires by inflating compressed air is between 100 to 400 kPa (1 to 4 bars) and pressure of the side rollers on the retread tires is between 200 to 600 kPa (2 to 6 bars) and (i) placing the retread tires in a curing chamber, characterized in that the chamber pressure is between 500 to 900 kPa (5 to 9 bars), the chamber temperature is between 70 to 100° C. and the time provided is between 3 to 4 hours.

The present invention consists of certain novel features and a combination of parts hereinafter fully described and illustrated in the accompanying drawings and particularly pointed out in the appended claims; it being understood that various changes in the details may be without departing from the scope of the invention or sacrificing any of the advantages of the present invention.

### BRIEF DESCRIPTION OF THE DRAWINGS

For the purpose of facilitating an understanding of the invention, there is illustrated in the accompanying drawings the preferred embodiments thereof from an inspection of which when considered in connection with the following description, the invention, its construction and operation and many of its advantages would be readily understood and appreciated.

FIG. 1 is a cross-sectional view of a rubber tread with the wing and shoulder;

FIG. 2 is a cross-sectional view of the rubber tread of FIG. 1 with the wing and shoulder wherein the wing is bendable;

FIG. 3 is a front view of the modified buffing machine according to the preferred embodiment of the present invention;

FIG. 4 is a top view of the buffing chamber of the modified buffing machine in FIG. 3;

FIG. 5 is a cross-section view of the buffing chamber of the modified buffing machine in FIG. 3;

FIG. 6 is a cross-section view of the side press machine which comprises the outer rim, ring and inner rim according to the preferred embodiment of the present invention;

FIG. 7 is a perspective view of the side press machine of FIG. 6 beautifying and stabilizing both sides of the retread tires.

### DETAILED DESCRIPTION OF THE PREFERRED EMBODIMENTS

The present invention relates to a process for retreading worn tires and the tires obtained therefrom. Hereinafter, this specification will describe the process according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications and equivalents without departing from the scope of the appended claims.

The worn tires will undergo initial inspection whereby the worn tires are selected and inspected. Tires that are not capable of service through a new tread life are rejected. Each selected and inspected worn tire will have its worn tread removed with the surface properly buffed to the correct size, shape and texture in order to receive a new tread. From then on, the worn tires are simply known as the casings (without a tread). At this stage the injuries/damages of the casings are repaired if they are within acceptable limits.

Thereafter, the casings are cemented using a type of rubber compound to prevent oxidation. The rubber compound normally used is Standard Malaysian Rubber (SMR). However, other rubber compounds can also be used depending on costs.

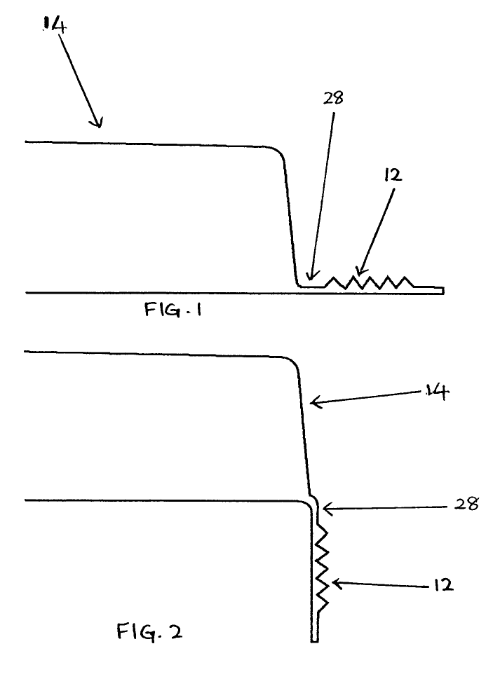

As shown in FIGS. 1 and 2, the shoulder (28) connecting the tread and the wing is bendable. The thickness of the shoulder (28) is normally between 0.2 and 3 mm. The general thickness of the wing (12) not taking into account of the shoulder (28) is between 0.5 and 5 mm. The width of the wing's shoulder (28) is between 1.5 and 10 cm depending on various makes.

The tread is cut to length to suit the individual casing and then buffed by a buffing machine modified by the present inventor.

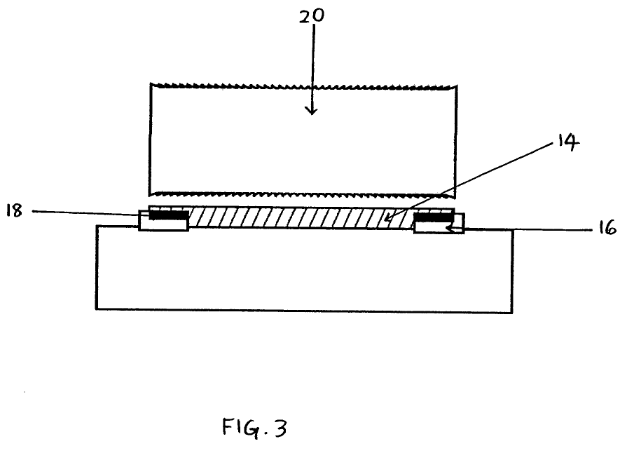

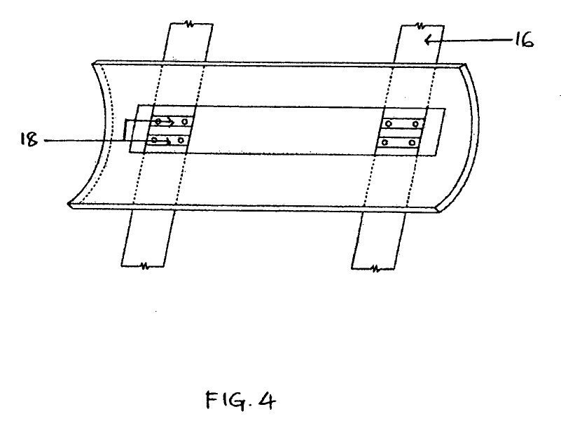

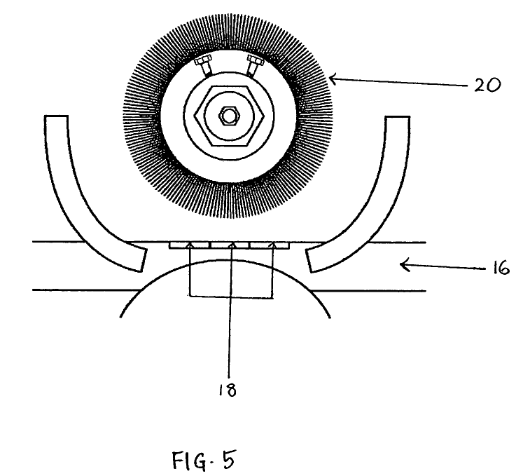

Reference is now made to FIGS. 3 to 5. The modified buffing machine is for the purpose of buffing the treads (14) in order that it can later be built onto the tires/casings for sealing. To procure a proper buffing, the buffing machine is provided with motor-driven steel rollers to transport the wing treads (14) into and through the buffing chamber, a pair of side rails (16) of permanent materials at each end of the said rollers to guide and lock in place the wing treads (14) in a fixed position with no side-way movements while being transported into and through the buffing chamber which is controlled by means of mechanical action for desired buffing. A support or a platform (18) made of hardened materials placed in a fixed position at each side just below the rotating steel brush (20) in the buffing chamber to protect the delicate wing (12) of the treads (14) during buffing. Conventional buffing machines do not have the above items and with these two modifications, the treads (14) can be buffed properly without deformity.

The working mechanism of the modified buffing machine is now described. Motor-driven rotating steel brush (20) buffs the underside of the wing treads (14). Upon detection of an incoming wing treads (14) by way of a sensor, the steel brush (20) is lowered to the desired buffing by means of mechanical action. A specially made hardened platform (18) placed and locked in at each end in the buffing chamber to provide support for the wing (12) ensuring that the same can be buffed evenly and thoroughly without deformation. The speed in which the wing treads (14) are transported into and out of the modified buffing machine will be between 1 to 5 cm per second. On the other hand, the force of the buffing on the treads (14) is between 1 to 7 kg and the speed of the buffing is between 1000 to 1800 rpm.

Industrial gum, such as cushion gum, is then applied to the buffed underside. However, it must be noted that other types of industrial gums can also be used instead of cushion gum used in the present process. When cured, this industrial gum will bond the treads (14) to the casings and become the strongest part of the retread tires.

The completed treads (14) are then built onto the casings using a tire builder machine, which has also being modified by the present inventor.

The modified tire builder builds tires/casings with that of the treads (14). The modified tire builder machine is equipped with controlled builder means for applying the treads (14) onto the casings in a receivable rotatable manner. The modified tire builder is also provided with a pair of side rollers operated by mechanical means capable of thrusting the wing (12) of the treads (14) onto the shoulder of the casings that has been applied with the industrial gum in order to cement them firmly. Further, the modified tire builder is also provided with means of leveraging said pair of rollers against the wing (12) onto the shoulder of casings. Conventional tire builders do not have the above item and thereafter based on this new step there is no need for envelope, innerlope, curing rim, pressure hose, vacuum hose and coupling prior to curing.

The casings are again kept in an inflated condition during this stage. Pressure of the tires/casings by inflating compressed air is between 100 to 400 kPa (1 to 4 bars), whilst the pressure of the side rollers on the shoulder of the tires/casings is between 200 to 600 kPa (2 to 6 bars).

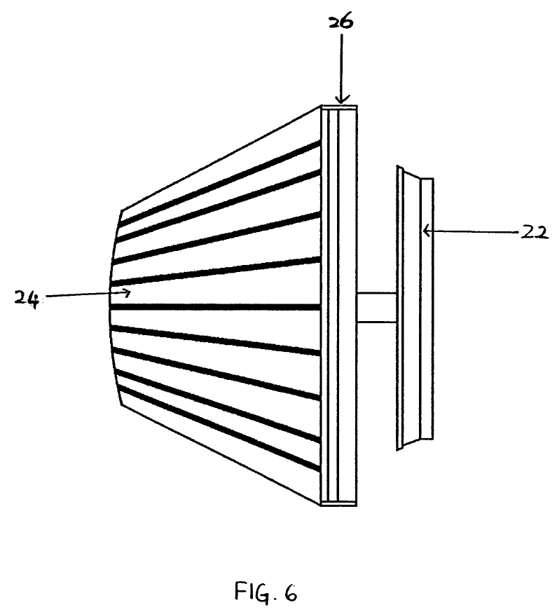

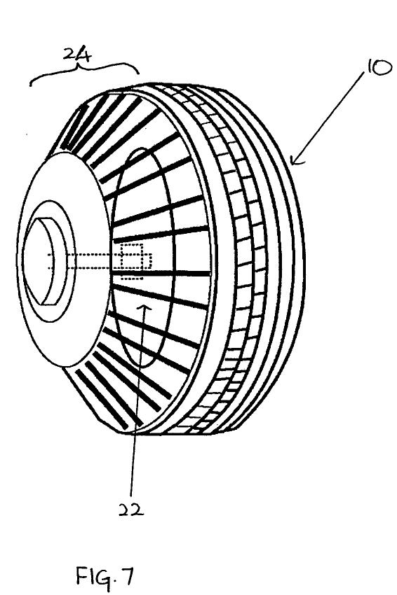

The retread tires are then loaded onto a side press machine which has been designed by the present inventor where it is again inflated and a pair of specially made hot plates is used to hot-press onto the side of the retread tires based on correct pressure, temperature and time. The side press machine is used for the purpose of beautifying and stabilizing both sides of the retread tires as well as to reinforce the sealing. The details of the side press machine can be viewed in FIGS. 6 to 7.

The side press machine is provided with a pair of inner rims (22) operated by mechanical means and capable of pressurizing the retread tires and a pair of outer rims (24) with circular rings (26) and attached together with the inner rims (22) by mechanical means. The rings (26) may vary in size and are connected with a pair of pneumatic/hydraulic pumps and means to provide source of vacuum and pressure. The side press machine is provided with a control circuit means. The said pneumatic/hydraulic pumps are controlled by electrical means is provided each at one side of chamber to provide inflation and deflation. A pair of circular plates variable in size is attached to the rings (26). The circular plates are connected to a control circuit means to provide source of heat. The rings (26) will provide beautifying and stabilizing effects onto both sides of the retread tires when heated up to the required temperature and for a period of time.

Pressure of the retread tires by inflating compressed air is between 100 to 400 kPa (1 to 4 bars) whilst the side press force pressure by hydraulic means is between 400 to 1200 kPa (4 to 12 bars). Water heating temperature is between 40 to 80° C. The time provided for the side pressing step is between 30 to 120 seconds whilst the cooling down period is between 5 to 15 minutes. In the preferred embodiment of the present invention, water is used as the heating means. However, it is envisaged that other heating means can be used to heat the rings (26) as well.

The retread tires are then placed into the curing chamber to vulcanise the bonding gum with the use of a hook. There is no particular design for the hook. The purpose of the hook is to hook the retread tires obtained from the present process during curing step so as to avoid being affected physically by the environment within. The chamber pressure is between 500 to 900 kPa (5 to 9 bars). The chamber temperature is between 70 to 100° C. The time provided for the curing step is between 3 to 4 hours.

As a matter of routine, the cured retread tires are inspected for the quality of the cure and integrity of the casings as well as tire cosmetics.

The retread tires obtained from the present process are therefore made through a simplified process without the need for conventional processes that require the use of envelope, innerlope, curing rim, pressure hose, vacuum hose and coupling. By eliminating such processes, the retread tires obtained from the present invention uses less machineries, less electricity, less waste, less time, less manpower, lower maintenance and better performance.

Based on researches, the retread tires obtained from the new process is significantly more efficient in terms of costs, productivity, performance and in the area of environmental protection. With this new process, there are savings on manpower, electricity and maintenance of machineries needed in the production of retread tires. It is also revolutionary in that at all material times the retreading industry has applied the same conventional methods or processes.

While in the foregoing specification this invention has been described in relation to certain preferred embodiments thereof and many details have been set forth for purpose of illustration, it will be apparent to those skilled in the art that the invention is susceptible to additional embodiments and that certain of the details described herein can be varied considerably without departing from the basic principles of the invention.

1. A process for producing retread worn tires, the said process comprises the steps of:
(a) selecting the worn tires which are fit to be retreaded;
(b) removing the treads of the worn tires;
(c) buffing the surface of the casings obtained from step (b) to the correct size, shape and texture;
(d) cementing the casings using a rubber compound;
(e) preparing new treads which suit the dimension of each casing;
(f) buffing the new treads using a buffer which is controlled by mechanical or pneumatic action, wherein the buffer is provided with motor-driven steel rollers, side rails of permanent materials acting as a guide at each side of the said rollers and a platform made of a hardened material placed in a fixed position at each side just below the rotating steel brush in the buffing chamber and characterized in that speed in which the treads being transported into and out of the buffer will be between 1 to 5 cm per second, the force of the buffing on the treads is between 1 to 7 kg and the speed of the buffing is between 1000 to 1800 rpm;
(g) applying an industrial gum on the underside of the buffed treads;
(h) attaching the buffed treads onto the casings using a tire builder, wherein the tire builder is provided with a controlled builder for applying the treads onto the casings, side rollers, means of leveraging said rollers against the wing onto the shoulder of casings characterized in that pressure of the retread tires by inflating compressed air is between 100 to 400 kPa (1 to 4 bars) and pressure of the side rollers on the retread tires is between 200 to 600 kPa (2 to 6 bars); and
(i) placing the retread tires in a curing chamber, characterized in that the chamber pressure is between 500 to 900 kPa (5 to 9 bars), the chamber temperature is between 70 to 100° C. and the time provided is between 3 to 4 hours.

2. The process according to claim 1, wherein the rubber compound is Standard Malaysian Rubber (SMR).

3. The process according to claim 1, wherein the industrial gum is cushion gum.

4. The process according to claim 1, wherein the retread tires are then loaded onto a side press after step (h), wherein the side press is provided with inner rims, outer rims with circular rings, a control circuit and plates which are connected to a control circuit to provide source of heat wherein the outer rims are attached together with the inner rims and wherein the rings are connected with pumps wherein the pumps are provided at each side of the chamber wherein the pressure of the retread tires by inflating compressed air is between 100 to 400 kPa (1 to 4 bars), the side press force pressure is between 400 to 1200 kPa (4 to 12 bars), heating temperature is between 40 to 80° C., the time provided for the side pressing step is between 30 to 120 seconds and the cooling down period is between 5 to 15 minutes.

5. The process according to claim 1, wherein the retread tires are placed into the curing chamber with the use of a hook.

6. The process according to claim 1, wherein the retread tires obtained are inspected for the quality of the cure and integrity of the casings as well as tire cosmetics.

7. Retread tires obtained from a process for producing retread worn tires, the said process comprises the steps of:
(a) selecting the worn tires which are fit to be retreaded;
(b) removing the treads of the worn tires;
(c) buffing the surface of the casings obtained from step (b) to the correct size, shape and texture;
(d) cementing the casings using a rubber compound;
(e) preparing new treads which suit the dimension of each casing;
(f) buffing the new treads using a buffer which is controlled by mechanical or pneumatic action, wherein the buffer is provided with motor-driven steel rollers, side rails of permanent materials acting as a guide at each side of the said rollers and a platform made of a hardened material placed in a fixed position at each side just below the rotating steel brush in the buffing chamber and characterized in that speed in which the treads being transported into and out of the buffer will be between 1 to 5 cm per second, the force of the buffing on the treads is between 1 to 7 kg and the speed of the buffing is between 1000 to 1800 rpm;
(g) applying an industrial gum on the underside of the buffed treads;
(h) attaching the buffed treads onto the casings using a tire builder, wherein the tire builder is provided with a controlled builder for applying the treads onto the casings, side rollers, and is configured for leveraging said rollers against the wing onto the shoulder of casings characterized in that pressure of the retread tires by inflating compressed air is between 100 to 400 kPa (1 to 4 bars) and pressure of the side rollers on the retread tires is between 200 to 600 kPa (2 to 6 bars); and
(i) placing the retread tires in a curing chamber, characterized in that the chamber pressure is between 500 to 900 kPa (5 to 9 bars), the chamber temperature is between 70 to 100° C. and the time provided is between 3 to 4 hours.

8. The retread tires according to claim 7, wherein the rubber compound is Standard Malaysian Rubber (SMR).

9. The retread tires according to claim 7, wherein the industrial gum is cushion gum.

10. The retread tires according to claim 7, wherein the retread tires are then loaded onto a side press after step (h), wherein the side press is provided with inner rims, outer rims with circular rings, a control circuit and plates which are connected to a control circuit to provide source of heat wherein the outer rims are attached together with the inner rims and wherein the rings are connected with pumps wherein the pumps are provided at each side of the chamber wherein the pressure of the retread tires by inflating compressed air is between 100 to 400 kPa (1 to 4 bars), the side press force pressure is between 400 to 1200 kPa (4 to 12 bars), heating temperature is between 40 to 80° C., the time provided for the side pressing step is between 30 to 120 seconds and the cooling down period is between 5 to 15 minutes.

11. The retread tires according to claim 7, wherein the retread tires are placed into the curing chamber with the use of a hook.

12. The retread tires according to claim 7, wherein the retread tires obtained are inspected for the quality of the cure and integrity of the casings as well as tire cosmetics.
